(19) United States
(12) Patent Application Publication
(10) Pub. No.: US 2008/0123639 A1
(43) Pub. Date: May 29, 2008

(54) Relay apparatus and routing method

(76) Inventors: Shiro Saito, Tokyo (JP); Kazuhiko Seki, Tokyo (JP)

Correspondence Address: INTELLECTUAL PROPERTY / TECHNOLOGY LAW, PO BOX 14329, RESEARCH TRIANGLE PARK, NC, 27709, US

(21) Appl. No.: 11/485,205

(22) Filed: Jul. 12, 2006

(51) Int. Cl. H04L 12/56

(52) U.S. Cl. 370/389

(57) ABSTRACT

Relay apparatus selecting first VoIP packets of at least the same transmission IP address from a plurality of VoIP packets arriving within a predetermined period, generating second VoIP packets taking a common transmission destination IP address as a transmission destination IP address and generating second VoIP packets containing each of the extracted media information, and substituting the first VoIP packets and routing the second VoIP packets.

### BACKGROUND

The present invention relates to technology for providing communication services such as calls etc. utilizing an IP (Internet Protocol) network, and particularly relates to routing technology for relay apparatus (gateway apparatus) used in VoIP (Voice Over IP) communication.

In recent years, technology (VoIP) for carrying out audio calls using IP has attracted attention, with “IP telephones” for carrying out calls based on VoIP starting to become widespread. In IP telephony, an analog audio signal corresponding to speech generated by a caller is converted into digital data, subjected to predetermined compression processing and then put into the form of packets for transmission to a call destination via a network. An analog audio signal is then restored at the call destination based on the received packets and outputted as audio. Technology of the related art relating to IP telephones is disclosed in documents such as, for example, Japanese Patent Laid-open Publication No. 2001-177577.

In the event of transmitting and receiving data using an IP, it is necessary for the original path selection (routing) to be carried out for the IP address so that a packet storing data reaches the correct destination. In a VoIP system, there are cases where gateway apparatus arranged between networks are equipped with a routing function.

FIG. 6 is a view schematically showing a typical configuration for a VoIP packet transmitted and received in a VoIP system. As is clear from the drawing, the VoIP packet has an IP header, UDP (User Datagram Protocol) header/TCP (Transmission Control Protocol) header, and RTP (Real-time Transport Protocol) header each packet.

### SUMMARY

In the event that more VoIP packets than expected arrive from each type of terminal etc. connected to a network at relay apparatus, it is not possible for the routing processing to catch up, and as a result, packet loss etc. occurs.

Further, as shown in FIG. 6, an IP header, UDP header/TCP header, and RTP header etc. are set at each VoIP packet. This causes transmission efficiency to fall due to overhead of the header portion the more the number of packets constituting the target of routing (i.e. packets transmitted by the relay apparatus) increases.

It is therefore the object of the present invention to reduce the number of packets that are the target of routing, suppress load relating to routing, and increase stability and transmission efficiency at relay apparatus.

Relay apparatus of the present invention comprises a selection section selecting packets of at least the same transmission IP address (in the following, the same transmission destination IP address is referred to as “common transmission destination IP address) from a plurality of VoIP packets arriving within a predetermined period, an extraction section for extracting media information from the respective selected VoIP packets (hereinafter referred to as “integration target VoIP packets”), a generating section taking the common transmission destination IP address as a transmission destination IP address and generating VoIP packets (hereinafter referred to as integrated VoIP packets) containing the extracted media information, and a routing section for substituting the integration target VoIP packets and routing the integrated VoIP packets.

The generating section preferably adjusts the packet length of the integrated VoIP packet based on the extent of packet loss.

The predetermined period is preferably 10 ms or 20 ms.

Upon receiving integrated VoIP packets generated by another relay apparatus, the relay apparatus of the present invention restores the integration target VoIP packets corresponding to the integrated VoIP packets and routes the restored integration target VoIP packet.

The routing method of the present invention selects integration target VoIP packets of at least the same transmission IP address from a plurality of VoIP packets arriving within a predetermined period, extracts media information from the respective selected integration target VoIP packets, takes the common transmission destination IP address as a transmission IP address, generates integrated VoIP packets containing the extracted media information, replaces the integration target VoIP packets and routes the integrated VoIP packets.

The routing method of the present invention can be executed by a program operating on a computer. The program can be installed or loaded in a computer either via various recording media such as a semiconductor memory such as a memory card, CD-ROM, or magnetic disc, or via a communication network.

In this specification, it is possible for one function to be implemented by two or more physical means, or for two or more functions to be implemented by one or more physical means.

According to the present invention, it is possible to reduce the number of packets that are the target of routing, suppress load relating to routing, and increase stability and transmission efficiency at relay apparatus.

### DESCRIPTION OF THE DRAWINGS

FIG. 1 is a block view showing a configuration for an overall system for the present invention.

FIG. 2 is a block view of functions of an IP telephone of the present invention.

FIG. 3 is a block view of GW functions of the present invention.

FIG. 4 is a flowchart showing the flow of packet integration processing.

FIG. 5A and FIG. 5B are views illustrating an integrated payload.

FIG. 6 is a view illustrating a VoIP packet.

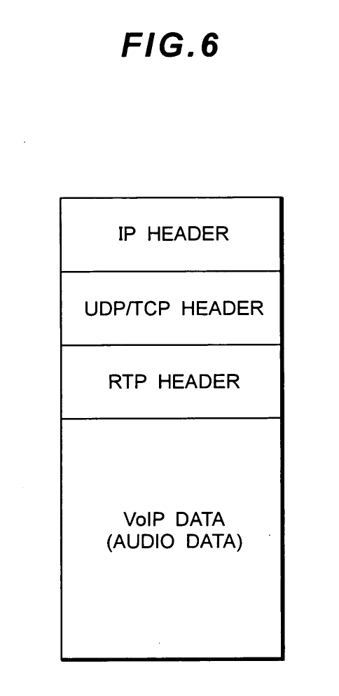

### DETAILED DESCRIPTION

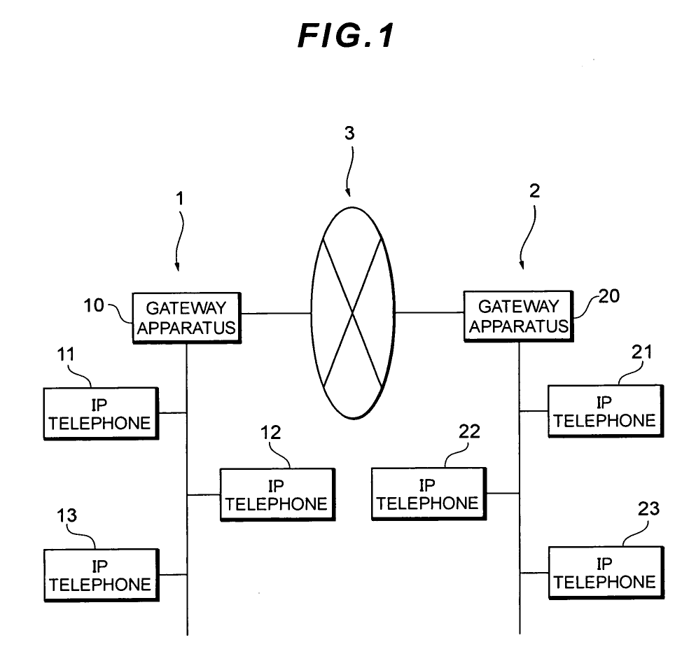

The following is a description using the drawings of an embodiment of the present invention. FIG. 1 is a block view representing the overall configuration of a system utilizing the present invention.

As shown in FIG. 1, the overall system contains a plurality of IP networks (IP network 1, IP network 2, IP network 3, etc.). Each IP network may be a LAN, dedicated IP network, or internet, etc.

Gateway apparatus 10 (GW10) equipped with a routing function and an IP telephone 11 and IP telephone 12 etc. are connected to the IP network 1. Gateway apparatus 20 (GW20) equipped with a routing function and an IP telephone 21 etc. is connected to the IP network 2.

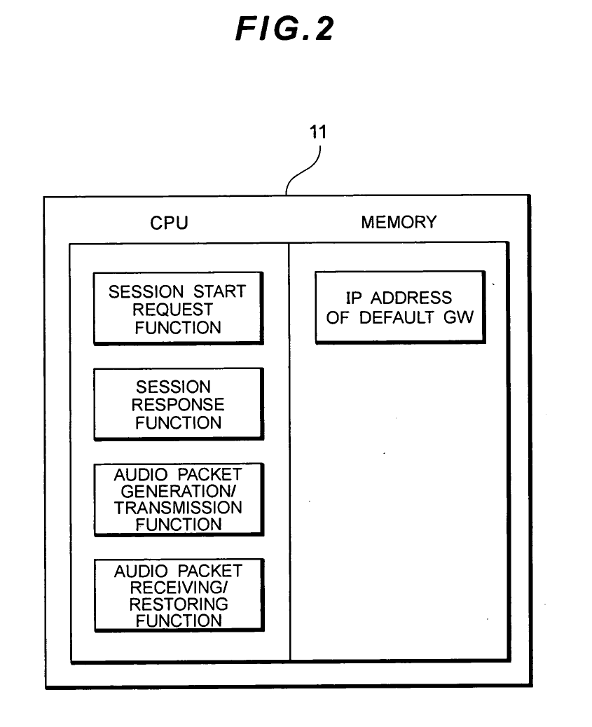

A block view of functions of an IP telephone is shown in FIG. 2 as an example of the IP telephone 11 connected to the IP network 1. As can be understood from the drawing, the IP telephone 11 stores an IP address etc. for GW 10 that is a default gateway apparatus for the IP network in a storage section.

Further, the IP telephone 11 is at least equipped with the normal functions of a typical IP telephone, such as a function for, in the event that, for example, a telephone number of a call destination is inputted by a user, sending an IP packet storing this telephone number as data to the destination GW10 and requesting start of a session, a function responding to establishment and discontinuation of a session etc., a function converting audio inputted by a user to digital data and transmitting this digital data as a VoIP packet (audio packet), and a function for receiving VoIP packets destined for itself, and restoring and outputting an analog audio signal, etc.

Existing technology such as PCM (Pulse Code Modulation) methods and CS-ACELP (Conjugate-structure algebraic code excited linear prediction) methods etc. can be utilized as methods for encoding audio according to the specification. For example, in the case of a high-speed line, a high tone quality PCM method may be adopted, and in the case of a low-speed line, a CS-ACELP method etc. capable of regulating bandwidth may be adopted.

Further, it is possible to decide protocols relating to session establishment etc. according to design, and it is possible to adopt, for example, H.323 protocol, SIP (Session Initiation Protocol), or a protocol conforming to this.

In addition to being configured as, for example, a dedicated IP telephone, the IP telephone 11 etc. can be configured as a combination of a typical telephone and terminal connection apparatus (TA apparatus) having each of the above functions, or a personal computer equipped with the necessary input/output interfaces mounted with an IP telephone module.

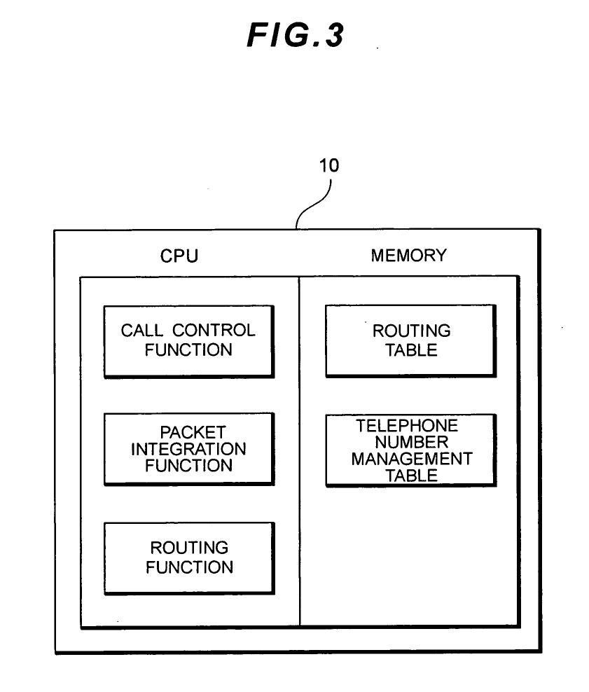

A functional block view of the gateway apparatus is shown in FIG. 3 as an example of GW10. As can be understood from the drawings, the GW10 stores a routing table for deciding which IP network of a plurality of IP networks connected to itself an IP telephone to receive packets exists on, or deciding which networks coincide with paths for reaching this IP telephone, and a telephone number management table for correlating telephone numbers of each telephone connected to the IP network 1 and IP addresses, in the storage section.

Further, GW10, 20 are equipped with at least the normal functions that typical relay apparatus and gateway apparatus are equipped with. For example, a call control function for negotiating with other apparatus on the path and establishing sessions based on session start requests from the IP telephone 11 etc., and a function (routing function) for interrogating predetermined location servers etc. for an IP address of a call destination terminal, referring to a routing table so as to determine a corresponding GW, and transferring VoIP packets etc.

However, GW10 and GW20 of this embodiment differ from the related art in being provided with a function (packet integration/routing function) for carrying out routing integrating at least packets for which at least the transmission destination IP addresses are the same as VoIP packets received from IP telephones 11, etc.

In addition to being configured as, for example, dedicated gateway apparatus, at information processing apparatus equipped with a typical configuration provided with a control section (CPU), input/output section, and storage section etc., the GW10, 20 may also be configured so that the program of the present invention executes a gateway apparatus organization program containing a program of the present invention. Each function described above can be implemented as a result of a CPU executing programs stored in a HDD, ROM, RAM, or external storage media etc. or may be implemented as functional sections using dedicated hardware.

GW10, 20 execute the packet integration processing described in the following at predetermined intervals in order to implement a packet integration/routing function. Each process of a packet integration function may be changed in order arbitrarily within a range that does not conflict with processing content or may be executed in parallel.

The predetermined intervals described above (intervals between executing packet integration processing) can be made to be, for example, transmission VoIP packet transmission intervals, and may specifically be, for example, 10 ms or 20 ms. Specifically, in the event that the VoIP system is organized based on CELP system audio encoding methods defined in ITU-T recommendation G.729, in this method, it is desirable to make the predetermined interval 10 ms after setting 10 ms as the audio encoding unit.

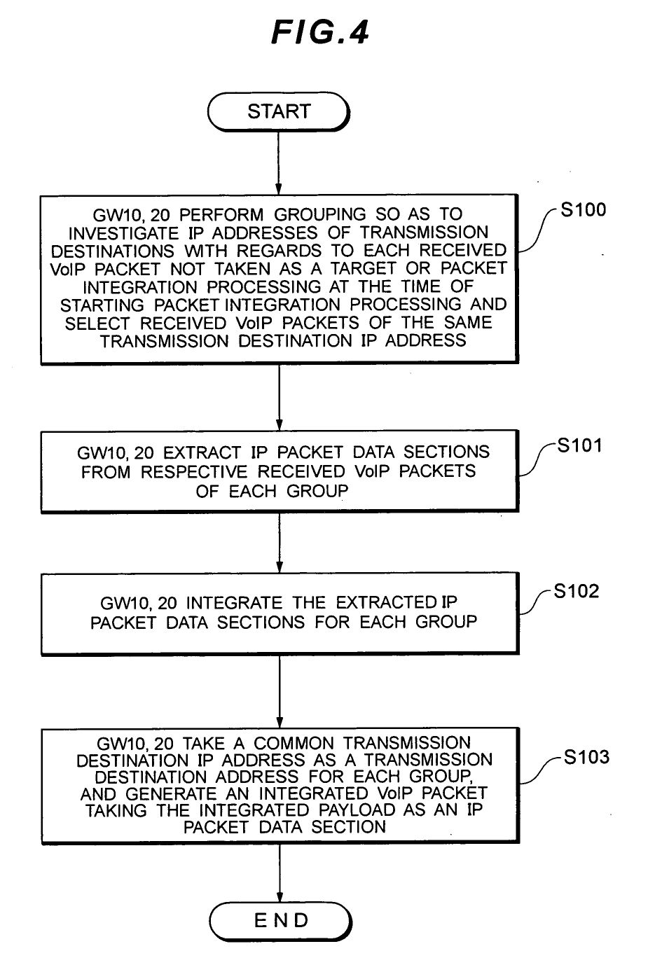

(Packet integration processing: FIG. 4)

GW10, 20 perform grouping so as to investigate IP addresses of transmission destinations with regards to each received VoIP packet not taken as a target or packet integration processing at the time of starting packet integration processing and select received VoIP packets of the same transmission destination IP address (S100). In the following, transmission destination IP addresses that are common to these received grouped VoIP packets are referred to as common transmission destination IP addresses.

Next, GW10, 20 extract IP packet data sections, i.e. UDP packets or TCP packets containing media information such as audio data etc. from the selected received VoIP packets for each group (S101).

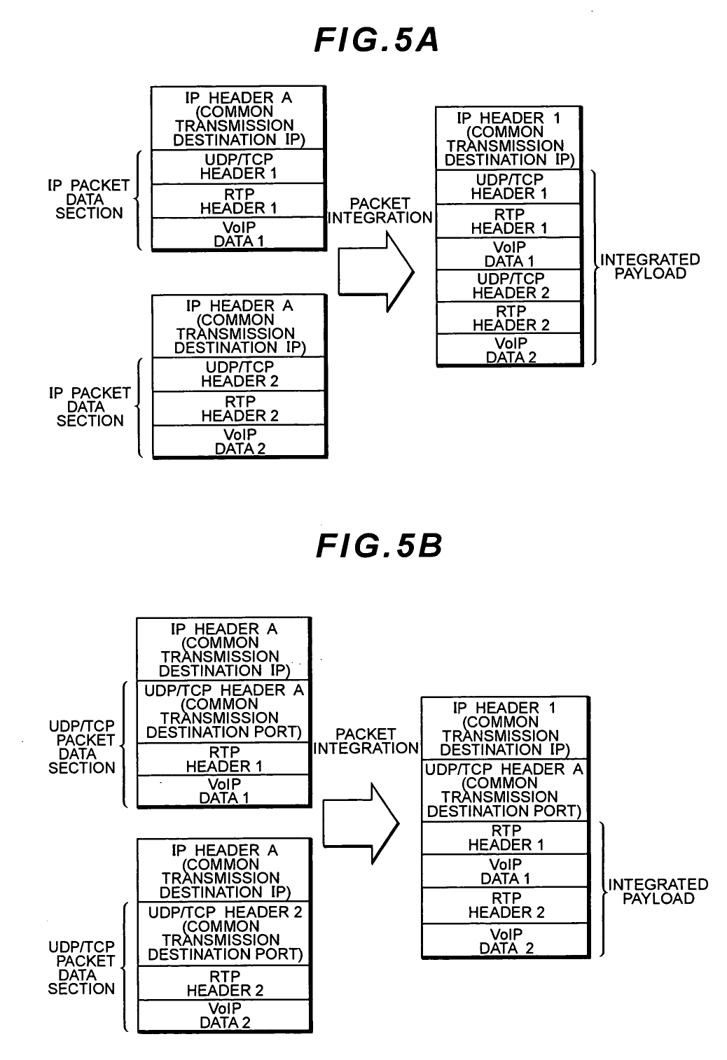

Next, GW10, 20 integrate the extracted IP packet data sections for each group (hereinafter, integrated data is referred to as “integrated payload”) (S102). A method where, as shown simply in FIG. 5A, the extracted IP packet data sections are, for example, arranged in the order of receipt to give an integrated payload can be considered as an integration method.

Next, GW10, 20 take a common transmission destination IP address as a transmission destination address for each group, and generate a VoIP packet (hereinafter referred to as an integrated VoIP packet) taking the integrated payload as an IP packet data section (S103). The received VoIP packets for each group have the same transmission destination IP address but the transmission source IP address does by no means have to be the same. Here, it is necessary to assign transmission source IP addresses to respective corresponding received VoIP packets for storage in an IP packet data section.

The GW10, 20 then execute routing processing as in the related art on the integrated VoIP packets generated by this kind of packet integration processing in place of the selected received VoIP packets (i.e. a succession of grouped received VoIP packets). Further, the same routing processing as in the related art is also executed for received VoIP packets (VoIP packets that are not integrated) that are not selected in S100.

According to the configuration of this embodiment, a plurality of received VoIP packets for which the transmission destination IP addresses coincide are integrated to generate a single integrated VoIP packet and this integrated VoIP packet is taken as a routing target. It is therefore possible to reduce the number of VoIP packets taken as routing targets compared with the case of executing routing processing as is without carrying out packet integration processing, and it is therefore possible to suppress the load relating to routing processing of the relay apparatus (gateway apparatus).

In the event that an integrated VoIP packet is received, and this common transmission destination IP address is not an address within an IP network GW10 and GW20 are themselves connected to, routing processing is carried out in the same way as for other VoIP packets, and in the event of an address within an own-connected IP network, individual VoIP packets (VoIP packets that are the target of integration) are restored based on the integrated VoIP packet and routing processing is carried out. The method for restoring the individual VoIP packets can be said in theory to be the reverse procedure of the packet integration processing. For example, IP packet data sections and transmission destination IP addresses of each VoIP packet taken as an integration target are extracted from the IP packet data section of the integrated VoIP packet, and each VoIP packet taken as a target of integration is restored based on the common transmission destination IP address, the extracted transmission destination IP address, and the extracted IP packet data section.

### (Modified Example)

The present invention is by no means limited to the above embodiment and application in various modifications is possible. For example, in the above embodiment, each IP telephone is equipped with a session start request function, session response function, and audio packet generation—transmission function/audio packet receiving—restoration function (codec function) etc. but the GW10, 20 may also be provided with each of these functions. In this event, it is possible to construct a VoIP system by providing relay apparatus equipped with a routing function of the present invention separately from the GW10, 20 having each of these functions.

Further, for example, a configuration is also possible where the extent of packet loss (packet loss rate) is detected based on, for example, an ACK signal and timer during generation of integrated VoIP packets at S103 of the above embodiment, and the of the integrated VoIP packet is adjusted based on the extent of this packet loss. For example, in the event that a plurality of packet lengths capable of being set are set in advance as the pre-integrated VoIP packet length, and the extent of the packet loss is a predetermined threshold value of T1 or more, on the one hand the packet length of the integrated VoIP packet is made substantially shorter than the current length in order to prevent tone quality deterioration etc. while in the case that the extent of packet loss is a predetermined threshold value of T2 or less, the packet length of the integrated VoIP packet for which the transmission efficiency is to be improved is changed to be substantially longer than is currently the case. A configuration may also be adopted where, in place of or in addition to the extent of the packet loss, the packet length of the integrated VoIP packets is adjusted based on the delay or fluctuation of the packets.

Further, a description is given of a configuration where in S100 of the aforementioned embodiment, received VoIP packets of the same transmission destination IP addresses are selected, but the present invention is by no means limited to this configuration. For example, a configuration may be adopted where the transmission destination port contained in the UDP/TCP header is investigated, grouping is performed by selecting received VoIP packets where the transmission destination IP address and the transmission destination port are the same, the UDP/TCP packet data is integrated, and integrated VoIP packets are generated (refer to FIG. 5B).

Further, for example, execution intervals for the packet integration processing may also be decided taking into consideration the received VoIP packet number and degree of congestion of the IP network. For example, a configuration may be considered where an execution interval of 10 ms may be adopted when the number of received VoIP packets is small, and the execution interval is made longer as the number of received VoIP packets increases.

1. A relay apparatus comprising:
a selection section for selecting a plurality of first VoIP packets having a common transmission destination IP address from a plurality of VoIP packets arriving at the relay apparatus within a predetermined period;
an extraction section for extracting media information from the respective first VoIP packets;
a generating section for generating a second VoIP packet including the common transmission destination IP address and the media information extracted from the respective first VoIP packets; and
a routing section for routing the second VoIP packet instead of the respective first VoIP packets.

2. The relay apparatus according to claim 1, wherein the generating section adjusts packet length of the second VoIP packet based on the extent of packet loss.

3. The relay apparatus according to claim 1, wherein the predetermined period is ten milliseconds or twenty milliseconds.

4. The relay apparatus according to claim 1, further comprising:
a receiving section for receiving the second VoIP packets generated by another relay apparatus;
a restoring section for restoring the respective first VoIP packets included in the second VoIP packet; and
a routing section for routing the restored first VoIP packets.

5. A routing method comprising the steps of:
selecting a plurality of first VoIP packets having a common transmission IP address from a plurality of VoIP packets arriving at a relay apparatus within a predetermined period;
extracting media information from the respective first VoIP packets;
generating a second VoIP packet including the common transmission destination IP address and the media information extracted from the respective first VoIP packets; and
routing the second VoIP packet instead of the respective first VoIP packets.
